(19) United States
(12) Patent Application Publication
(10) Pub. No.: US 2009/0034461 A1
(43) Pub. Date: Feb. 5, 2009

(54) MULTIPLE INPUT MULTIPLE OUTPUT (MIMO) MODE OPTIMIZATION FOR LOW DATA RATES SERVICES

(75) Inventors: Benoit Pelletier, Roxboro (CA); Christopher R. Cave, Verdun (CA); Paul Marinier, Brossard (CA); Eldad M. Zeira, Huntington, NY (US); Philip J. Pietraski, Huntington Station, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/141,828

(22) Filed: Jun. 18, 2008

Related U.S. Application Data
(60) Provisional application No. 60/944,633, filed on Jun. 18, 2007.

(51) Int. Cl. H04W 72/04; H04L 27/28

(52) U.S. Cl. 370/329; 375/267

(57) ABSTRACT

A method and an apparatus are provided for efficient transmission of low-data-rate packet services in a multiple-input multiple-output (MIMO) mode of operations in the presence of high-data-rate packet services. Precoding weight information (PWI) is signaled implicitly to a wireless transmit receive unit (WTRU). A precoding weight vector is signaled in a high speed shared control channel less (HS-SCCH-less) transmission using a new HS-SCCH type P. This explicit PWI signaling approach transmits the PWI with minimum power overhead. The data carried in the HS-SCCH type P is encoded to minimize the required transmitted power. A channel type HS-SCCH type 2M is also described.

### CROSS REFERENCE TO RELATED APPLICATIONS

This application claims the benefit of U.S. provisional application No. 60/944,633 and having a filing date of Jun. 18, 2007, which is incorporated by reference as if fully, set forth.

### FIELD OF INVENTION

This application is related to wireless communications.

### BACKGROUND

In wireless communications, there is a growing consumer demand for services that provide increased data rates and capacity for downlink packet access. Therefore, the third Generation Partnership Project (3GPP) introduced a High Speed Downlink Packet Access (HSDPA) which offers high downlink transfer speeds and High Speed Uplink Packet Access (HSUPA) which offers high uplink transfer speeds. The HSDPA and HSUPA are commonly referred to as High Speed Packet Access (HSPA).

It has become increasingly popular to use multi-antenna systems in wireless communications networks to improve channel capacity, spectrum efficiency, system throughput, peak data rates, and link reliability. The multi-antenna systems are generically referred to as multiple-input-multiple-output (MIMO) systems but may also include multiple-input-single-output (MISO) and or single-input-multiple-output (SIMO) configurations.

Precoding information is transmitted from the Node-B to a wireless transmit receive unit (WTRU) to avoid a channel mismatch between transmitting and receiving signals. The limited sets of antenna weight coefficients are sometimes referred to as a precoding codebook. Explicit signaling to communicate precoding information may incur a large signaling overhead, particularly for a large size codebook. Accordingly, a precoding matrix or antenna weight validation and verification may be used to avoid channel mismatch. An effective channel between the Node-B and the WTRU is a channel that experiences MIMO precoding effect, and is the multiplication of channel matrix and precoding matrix used at the Node-B. A mismatch of the effective channel causes severe performance degradation for MIMO communication systems.

3GPP introduces a MIMO mode for both HSDPA single stream and HSDPA dual stream operation. In a single stream operation, a single transport block is transmitted from both antennas. In dual stream operations, two transport blocks are transmitted simultaneously from both antennas. For both cases, a linear weighting is applied at each antenna, and a precoding weight vector is selected from a finite set based on a closed-loop mechanism where the receiver signals the preferred precoding weight vector back to the transmitter. This is accomplished as part of the precoding control information (PCI)/channel quality indicator (CQI) report. When using dual stream operation, the downlink peak data rate for MIMO capable terminals is doubled.

FIG. 1A shows the channel structure of HSDPA. The downlink information is carried on shared channels (101) the High-Speed Downlink Shared Channel (HS-DSCH) and High Speed Shared Control Channel (HS-SCCH) channels. The uplink data is carried on one or more dedicated channels (102). There is also an uplink signaling channel called high-speed dedicated physical control channel (HS-DPCCH) and an extra dedicated downlink channel to carry power commands to the WTRU for uplink power control. The downlink channels are shared between every WTRU in the cell. High Speed-Physical Downlink Shared Channel (HS-PDSCH) is a physical constituent of the HS-DSCH, a transport channel. All other channels (i.e., DPCH, DPCCH, and DPDCH) in FIG. 1A are physical channels.

Another improvement in HSDPA is the HS-SCCH-less mode which is mode of operation in which the channel overhead is reduced. In the conventional mode, the WTRU continuously monitors the HS-SCCH when data allocations are being signaled. The WTRU is addressed via a WTRU specific identity, a 16-bit HSDPA Radio Network Temporary Identifier (H-RNTI), on the HS-SCCH. When the WTRU detects relevant control information on the HS-SCCH, it immediately switches to the associated HS-PDSCH resources and receives the data packet. However, in HS-SCCH-less operation, the Node-B determines for each packet again whether to apply HS-SCCH operation. If not, the conventional method may still be applied.

FIG. 1B shows an HS-SCCH operation. The H-SCCH operation includes an initial transmission (102), a first retransmission (104), and a second retransmission (105). The initial transmission of data packet (103) on the HS-DSCH is prepared without an associated HS-SCCH and using quadrature phase shift keying (QPSK) and redundancy version Xrv set to zero. There are four pre-defined transport format combinations (TFCs) that may be used for blind TFC detection and are configured by higher layers. The pre-defined channelization codes are used and configured per WTRU by the higher layers. To allow detection of the packets on HS-DSCH, the cyclic redundancy check (CRC) is WTRU specific and is based on the 16 bit H-RNTI. If the packet is successfully received, the WTRU transmits an ACK on the HS-DPCCH. If the packet was not received correctly, the WTRU sends nothing.

Referring to the first retransmission (104) and second retransmission (105) in FIG. 1B, if the packet is not received in the initial transmission, the Node-B may retransmit the packet. For retransmissions in HS-SCCH-less operation, HS-SCCH type 2 signaling is used and the number of retransmissions is limited to two. Table 1 shows characteristics of HS-SCCH type 1 and HS-SCCH type 2 signaling.

TABLE 1

| HS-SCCH type 1 | HS-SCCH type 2 |
|---|---|
| Channelization code set information | Channelization code set |
| (7 bits) | information (7 bits) |
| Modulation scheme information (1 bit) | Modulation scheme information |
| | (1 bit) |
| Transport block size information (6 bits) | Special information type |
| | (6 bits) |
| Hybrid ARQ process (3 bits) | Special information (7 bits) |
| Redundancy and constellation version | |
| (3 bits) | |
| New Data Indicator (1 bit) | |
| WTRU identity (16 bits) | WTRU identity (16 bits) |

The HS-SCCH type 2 frame includes a Special Information Type that is set to 111110 to indicate HS-SCCH-less operation. The seven bit Special Information contains: a two bit transport block size information (one of the four possible transport block sizes as configured by higher layers), a three bit pointer to the previous transmission of the same transport block (to allow soft combining with the initial transmission), 1 bit indicator for the second or third transmission, and 1 bit is reserved.

An HS-SCCH type 3 has also been defined for MIMO operations. If one transport block is transmitted, the following information is carried in the first part of the HS-SCCH type 3: channelization-code-set information (X_{ccs}=7 bits), modulation scheme (Xₘₛ) and number of transport blocks information (3 bits), precoding weight information (X_{pwi}=2 bits), and identity of the WTRU (X_{WTRU}=16 bits). The second part of the HS-SCCH type 3 carries the following information: transport-block size information (X_{tbs}=6 bits), Hybrid-Automatic Repeat Request (HARQ) process information (Xₕₐₚ=4 bits), redundancy/constellation version (Xᵣᵥ=2 bits), and identity of the WTRU (X_{WTRU}=16 bits).

FIG. 1C illustrates the HS-SCCH type 3 coding scheme for a case wherein there is transmission of two transport blocks. The redundancy version parameters r and s, and the constellation version parameter b are input into the RV coding (115 and 116). The RV coding (115) generates a redundancy/constellation version for primary transport block (X_{rvsb}). The RV coding (116) generates a redundancy/constellation version for primary transport block (X_{rvpb}). These two versions along with transport-block size information for the primary transport block (X_{tbspb}), the transport-block size information for the secondary transport block (X_{tbssb}), and the HARQ process information (Xₕₐₚ) are carried by the second portion of the HS-SCCH type 3 frame. These are all combined (107) to generate X₂. The X₂ information and identity of the WTRU (X_{WTRU}) along with X₁ are transmitted to the WTRU specific CRC attachment (108) to generate Y bits.

The channelization code set information X_{ccs}, the channelization modulation scheme Xₘₛ and precoding weight information for the primary transport block (X_{pwipb}) are combined (106) to generate X₁. The X₁, X₂, Z₁, Z₂, R₁, R₂, S₁, and Y are a sequence of bits containing respective number of bits for its inputs. X₁ and Y are used for channel coding 1 (109) and channel coding 2 (110) to encode into vectors and outputs it as Z₁ and Z₂ for rate matching 1 (111) and rate matching 2 (112), respectively. The WTRU specific masking (113) takes in the identity of the WTRU in order to input the masking into the Physical Channel Mapping (114).

FIG. 1D shows the HS-SCCH and the HS-PDSCH timing relationship. To decode the HS-PDSCH, the WTRU requires a channelization code set, the modulation scheme, and the precoding weight index. Accordingly, channelization code set, the modulation scheme, and the precoding weight index are transmitted in the first part of the HS-SCCH, which is transmitted two radio slots before the beginning of the associated HS-PDSCH. This timing allows the WTRU to configure its radio parameters before the HS-PDSCH is received.

A MIMO capable WTRU may be configured in MIMO mode through radio resource control (RRC) (i.e., layer 3) signaling. The HS-SCCH type 3 further indicates the modulation format and number of transport blocks along with the precoding weight vector used for the transmission of the associated HS-PDSCH. Knowledge of the precoding weight vector is essential to the WTRU for optimal signal detection. While the WTRU regularly transmits the preferred weight vector back to the Node-B, the latter may chose to use a different precoding weight vector.

The MIMO feature has been developed for high-data-rate packet services; it is not optimized for low-data-rate services such as voice over internet protocol (VoIP). However, the WTRU in MIMO mode may receive high-data-rate packet services (e.g., web browsing, multimedia content, etc.), while also receiving low-data-rate packet services (e.g., VoIP). In the latter case, transmission of the HS-SCCH represents a large overhead when compared to the number of information bits transmitted on the HS-PDSCH and it is very power-inefficient.

FIG. 1E shows a timing diagram for HS-SCCH-less operations. The HS-SCCH-less provides increased power efficiency of HSDPA for low-data-rate packet services such as VoIP. Referring to FIG. 1E, the HS-SCCH is not transmitted during the first HARQ transmission. The WTRU is configured by higher layers to monitor a given channelization code set for a given modulation format and a redundancy version so that the transport block size is blindly detected on the first transmission. In case of failure, the second transmission (Tx2) and third transmission (Tx3) of the same transport block are accompanied by an associated HS-SCCH type 2.

The current systems do not allow HS-SCCH-less operations in MIMO mode. In MIMO mode, the precoding weight information (PWI) associated with a given HS-PDSCH is signaled to the WTRU in the first part of the HS-SCCH type 3, along with the modulation information and the number of transport blocks. Because the precoding weight vector varies with the channel and it is needed for signal detection, it is difficult to estimate the PWI blindly. Moreover, the Node-B has no actual means to transmit this information to the WTRU.

Therefore a method for minimizing the transmit power in MIMO mode for optimization of low data rate services is desired.

### SUMMARY

A method and an apparatus are provided for efficient transmission of low-data-rate packet services in MIMO mode of operation in the presence of high-data-rate packet services. The PWI is signaled implicitly to a wireless transmit receive unit (WTRU). A precoding weight vector is signaled in a HS-SCCH-less transmission using a new HS-SCCH type P. This explicit PWI signaling approach transmits the PWI with minimum power overhead. The data carried in the HS-SCCH type P is encoded to minimize the required transmitted power. Also, different transmit diversity is used for HS-SCCH-less operations when the WTRU is configured in MIMO mode of operations.

A method and an apparatus for transmission of packet services implemented in a MIMO capable WTRU determining a PWI, receiving a HS-PDSCH, and decoding the HS-PDSCH based on the PWI is also described.

### BRIEF DESCRIPTION OF THE DRAWINGS

A more detailed understanding may be had from the following description, given by way of example in conjunction with the accompanying drawings wherein:

FIG. 1A shows an overview of a conventional HSDPA channel structure;

FIG. 1B shows a conventional HS-SCCH less-operations;

FIG. 1C is a conventional coding scheme for HS-SCCH type 3;

FIG. 1D shows a timing relationship between a conventional HS-SCCH and HS-PDSCH;

FIG. 1E is a timing diagram for a conventional HS-SCCH-less operations;

FIG. 2A shows a conventional HS-SCCH type P for the first transmission of HS-SCCH-less operations in MIMO mode;

FIG. 2B shows a HS-SCCH type P for the first transmission of the HS-SCCH-less operations in MIMO mode in accordance with a preferred embodiment;

FIG. 3 is a diagram for HS-SCCH type P coding; and

FIG. 4 is a diagram for HS-SCCH type 2M coding.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

As will be used herein a wireless communication system may include a plurality of WTRUs, a base station, and an radio network controller (RNC). The WTRUs may be in communication with the base station, which is in communication with the RNC. It should be noted that any combination of wireless and wired devices may be included in the wireless communication system. The WTRU is in communication with the base station and both are configured to perform a method for packet services implemented in a MIMO capable WTRU.

In addition to the components that may be found in a typical WTRU, the WTRU includes a processor, a receiver, a transmitter, and an antenna. The processor is configured to perform packet services implemented in a MIMO capable WTRU. The receiver and the transmitter are in communication with the processor. The antenna is in communication with both the receiver and the transmitter to facilitate the transmission and reception of wireless data.

In addition to the components that may be found in a typical base station, the base station includes a processor, a receiver, a transmitter, and an antenna. The processor is configured to packet services implemented in a MIMO capable WTRU. The receiver and the transmitter are in communication with the processor. The antenna is in communication with both the receiver and the transmitter to facilitate the transmission and reception of wireless data.

In a first embodiment, implicit PWI signaling is utilized to implement HS-SCCH-less transmission in MIMO mode. For a HS-SCCH-less first transmission in MIMO mode, the WTRU may use the following alternatives to determine which precoding weight vector to use for detection of the HS-PDSCH.

In a first alternative, the WTRU and the Node-B may be configured to use the precoding weight vector signaled on the last HS-SCCH transmitted by the Node-B. In this alternative, the WTRU maintains a most recently received precoding weight index (RR_PWINDX). This index is updated every time an HS-SCCH addressed to that WTRU, carrying the PWI (e.g., HS-SCCH type 3), is received. The WTRU then configures its receiver to use the precoding weight associated with this RR_PWINDX to blindly decode the HS-PDSCH for the HS-SCCH-less operations.

In a second alternative, the WTRU and the Node-B may be configured to use the last preferred precoding weight vector transmitted on the HS-DPCCH, after a pre-defined delay to account for decoding at the Node-B. In this case, the WTRU may blindly detect the precoding weight against the possibility that the HS-DPCCH transmission has not been correctly received by the Node-B. In this alternative, the WTRU maintains the most recent transmitted precoding weight index (RT-PWINDX). This RT_PWINDX is updated every time the WTRU transmits a new PCI on the HS-DPCCH. The WTRU then configures its receiver after a pre-defined or configured delay, to use the precoding weight associated with the RT_PWINDX to blindly decode the HS-PDSCH for HS-SCCH-less operations.

In a third alternative, the WTRU may be configured to use the most recent precoding weight vector among the first alternative and second alternative. In this alternative, the WTRU maintains a most recent precoding weight index (R-PWINDX). This R_PWINDX is updated every time the WTRU transmits a new PCI on the HS-DPCCH. Alternatively, the R_PWINDX may be updated every time the WTRU successfully decodes an HS-SCCH carrying the PWI (e.g., HS-SCCH type 3) addressed to the WTRU. The WTRU then configures its receiver, possibly after a pre-defined or configured delay depending on the above case, to use the precoding weight associated with the R_PWINDX to blindly decode the HS-PDSCH for HS-SCCH-less operations.

In a fourth alternative, the WTRU and the Node-B may be configured to use a fixed pre-defined precoding weight vector that is either signaled from higher layers or pre-configured. A single antenna transmission is a special case of this embodiment. In this alternative, the WTRU configures its receiver for a fixed precoding weight to blindly decode the HS-PDSCH associated with the HS-SCCH-less operations.

In a fifth alternative, the WTRU may be configured to use the precoding weight vectors according to the first alternative, second alternative, or third alternative, until a pre-defined timer expires, at which point the WTRU reverts to the fourth alternative. The timer duration is reset when a new PWI is available (either through first alternative or second alternative). The duration may be pre-defined or signaled by higher layers.

As an alternate for all five of the alternatives, or in combination, the WTRU may blindly detect the precoding weight.

Optionally, the network may predict the behavior of the WTRU and based on this behavior the network may determine if the HS-PDSCH should be transmitted with an associated HS-SCCH. The network may decide whether to transmit the HS-SCCH depending on the precoding weights expected by the WTRU.

In an alternate embodiment, explicit PWI signaling is utilized. In this approach, the precoding weight vector is signaled in the first HS-SCCH-less transmission using a new HS-SCCH type P. Although the HS-SCCH is transmitted for the first HARQ transmission, the approach may be considered as HS-SCCH-less as the new HS-SCCH type P carries much less information than the HS-SCCH type 1, HS-SCCH type 2, or HS-SCCH type 3 and requires much less transmission power. The WTRU also has to perform blind transport block size detection.

The explicit PWI signaling approach may be advantageous if the network is transmitting the PWI with minimum power overhead. The data carried in the HS-SCCH type P is encoded to minimize the required transmitted power. Alternatives for associating the PWI signaling to the HS-PDSCH are provided below.

A first alternative for associating the PWI signaling with the HS-PDSCH is associating the PWI signaling with the WTRU identity by cyclic redundancy check (CRC) masking with a WTRU identity number (e.g., high speed downlink shared channel (HS-DSCH) radio network temporary identifier (H-RNTI)). This may be achieved by re-using the first part of the current HS-SCCH type 3 and setting the channelization code set and modulation scheme to a reserved value. In one alternative, a new HS-SCCH order is used for this purpose, which may indicate to the WTRU to set the receiver precoding weight to the value indicated in the first part of the HS-SCCH.

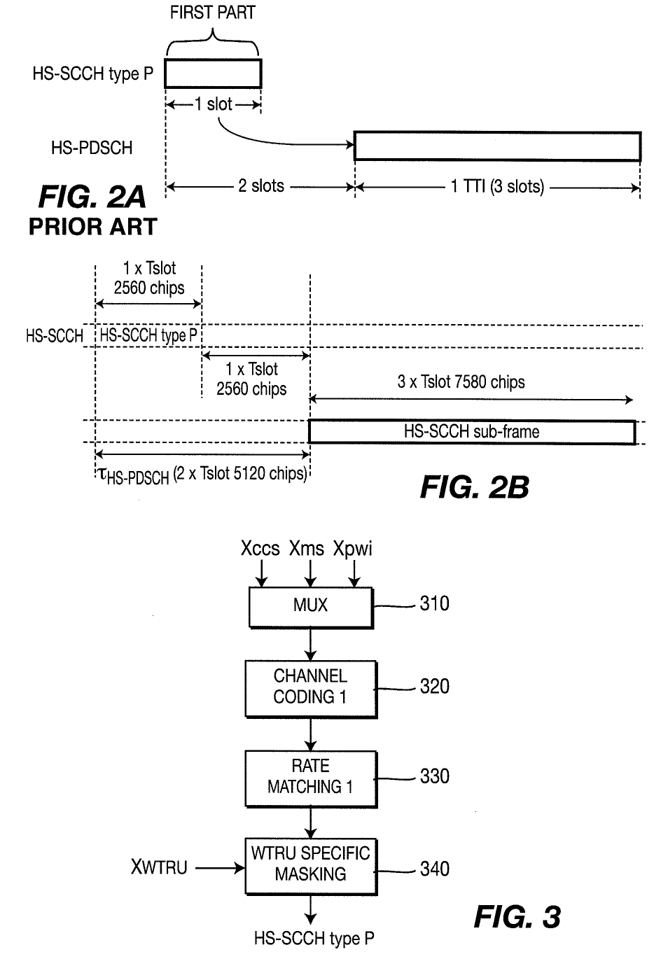

FIG. 2A and FIG. 2B illustrate timeslots for transmission. FIG. 2A shows a conventional HS-SCCH type P transmission for the first transmission of HS-SCCH-less operations in MIMO mode.

FIG. 2B shows a preferred embodiment wherein the HS-PDSCH is transmitted in a timeslot, starting before the beginning of the HS-SCCH subframe to allow sufficient time for detection. The reserved value of the timeslots is different than the value selected for the HS-SCCH orders and no associated second part of HS-SCCH is transmitted. In FIG. 2A and FIG. 2B, the HS-SCCH type P carries the WTRU identity via the H-RNTI and the PWI values associated with the first HS-PDSCH for HS-SCCH-less transmission in MIMO mode. In this case, the coding for the HS-SCCH type P may include the existing coding of the first part of the HS-SCCH type 3 with a pre-defined or configured value for channelization-code-set information (Xccs) and modulation scheme information (Xms) bits.

FIG. 3 illustrates HS-SCCH type P coding. First, input variables X_{ccs}, Xₘₛ, and X_{pwi} are multiplexed together by mux (310) into a sequence of bits for channel coding 1 (320). The sequences of bits are an input to the rate matching 1 (330). The output of the rate matching 1 and the identity of the WTRU is masked by the WTRU specific masking (340) for HS-SCCH type P coding.

There are several alternatives in which the pre-coding information may be coded and transmitted.

In a first alternative, the precoding information may be coded and transmitted in a single timeslot, starting two timeslots before the beginning of the HS-SCCH subframe to allow sufficient time for detection.

Alternatively, the choice of slot (one of three) may specify some of the information bits above. And, further alternatively, more than one timeslot may be transmitted. For example, The HS-SCCH type P may be repeated for increased reliability or reduced transmission power.

In a second alternative, the precoding information may be coded and transmitted in three time slots similar to other HS-SCCH types, the channel coding used for HS-SCCH type 1, HS-SCCH type 2, or HS-SCCH type 3 may be used also for HS-SCCH type P with an appropriate precoding multiplication matrix.

A second alternative related to associating the PWI signaling with the HS-PDSCH is associating PWI signaling with the channelization code or codes used to carry the HS-PDSCH.

In current HS-SCCH-less operations, the WTRU may be configured by the network to monitor a subset of HS-SCCH channelization codes (e.g., up to four). In this embodiment, a specific PWI is configured for each HS-SCCH channelization code. The WTRU then configures its receiver for a set of HS-SCCH channelization codes, PWI pairs. The decoding is blind, but the set of possibilities for the HS-SCCH channelization code and the PWI is significantly reduced. This may be implemented by adding a new entry in the physical channel information element called HS-SCCH-less information. This is illustrated in Table 2.

TABLE 2
HS-SCCH-less information (prefrebly for FDD)

| Information | | | | |
|---|---|---|---|---|
| Element/ | | | Type and | Semantics |
| Group name | Need | Multi | reference | description |
| Precoding | OP | | Integer | Indicates the |
| weight | | | (0 . . . 3) | precoding weight |
| | | | | index in the case |
| | | | | MIMO_STATUS |
| | | | | variable is |
| | | | | TRUE. |

In Table 2, the column indicated uses the term ‘OP’ which indicates optional is typically defined as the presence or absence is significant and modifies the behavior of the receiver. However whether the information is present or not does not lead to an error diagnosis. The column labeled “Multi” in the information element table is used to indicate that there could be multiple instances of a given row (or set of rows) taking different values. When this is the case, there is an indication in the “Multi” column as to how many of those are present (e.g., 1 . . . <maxNumber>).

HS-SCCH type 2M for retransmissions

The HS-SCCH type 2 carries additional information for HS-SCCH-less operations: six bits for special information type with special value “111110” to indicate HS-SCCH-less operation, 1 bit to indicate if the current transmission is the second or third, and a three bit pointer indicating when the previous transmission of the same transport block started.

The number of bits to indicate the transport block size information has been reduced to two. No bits are transmitted to indicate the HARQ process or the redundancy and constellation version as this information is pre-defined in the HS-SCCH-less operation setup.

Similarly, for the HS-SCCH-less operations in MIMO mode, a new HS-SCCH type is required. The new HS-SCCH type is referred to as HS-SCCH type 2M. For HS-SCCH-less operations in MIMO mode, the PWI is signaled to the WTRU in a first part of the HS-SCCH within the first timeslot. Therefore, the first part of the HS-SCCH type 2M may contain not only the channelization code set information and modulation scheme information, but also the PWI.

The second part of the HS-SCCH type 2M (i.e., the following two timeslots) may be constructed as defined in the 3GPP, or as the current second part of HS-SCCH type 2 is constructed.

The following information may be transmitted via the HS-SCCH type 2M physical channel for the second and third transmission. It is understood that the number of bits in each case may differ. In the first part, X_{ccs} has 7 bits, Xₘₛ has 1 bit, and X_{pwipb} has 2 bits; and, in the second part, special information type (X_{type}) has 6 bits and special information (X_{info}) has 7 bits.

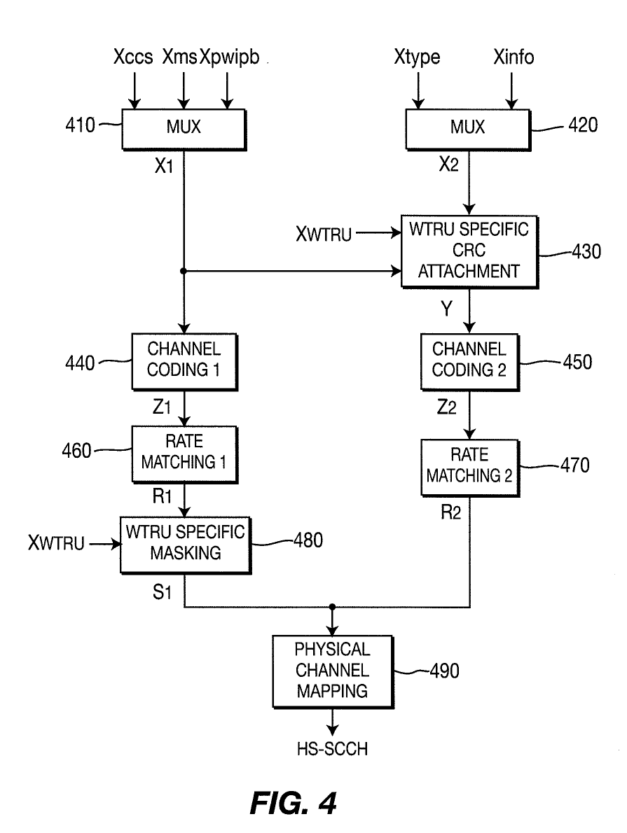

The coding for the HS-SCCH type 2M is illustrated in FIG. 4. The CRC is masked by the WTRU identity of 16 bits. When the WTRU is configured in MIMO mode, it knows that the first part of the HS-SCCH transmitted (i.e., type M or 2M) contains the PWI bits. The special information type in second part of the HS-SCCH type 2M indicates that the current transmission relates to the HS-SCCH-less operation while the special information field contains information specific to that HS-SCCH-less operation.

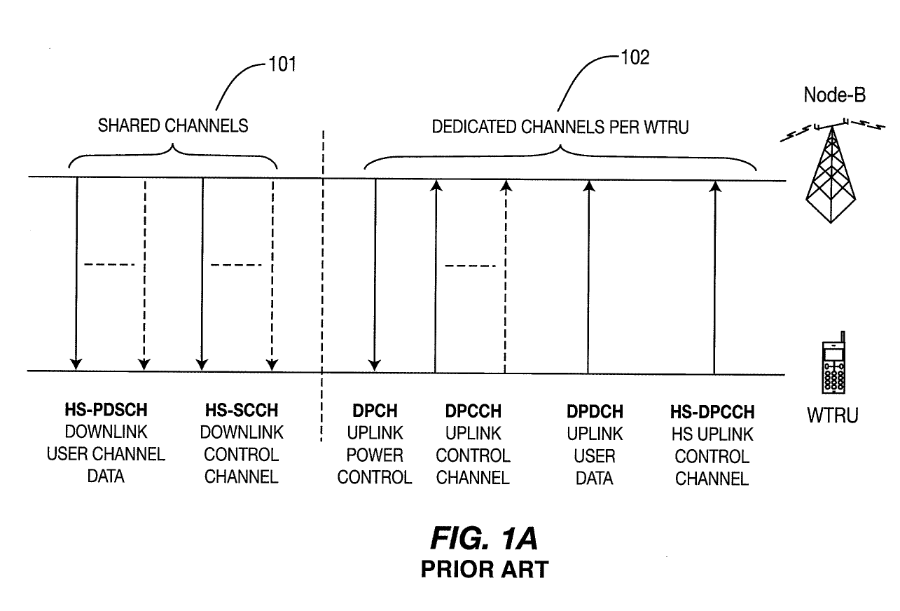

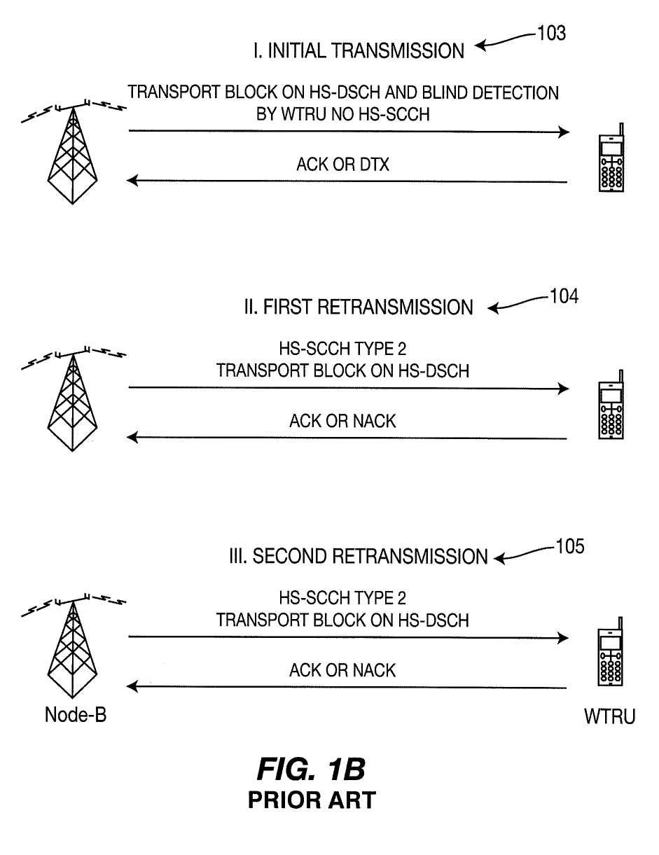

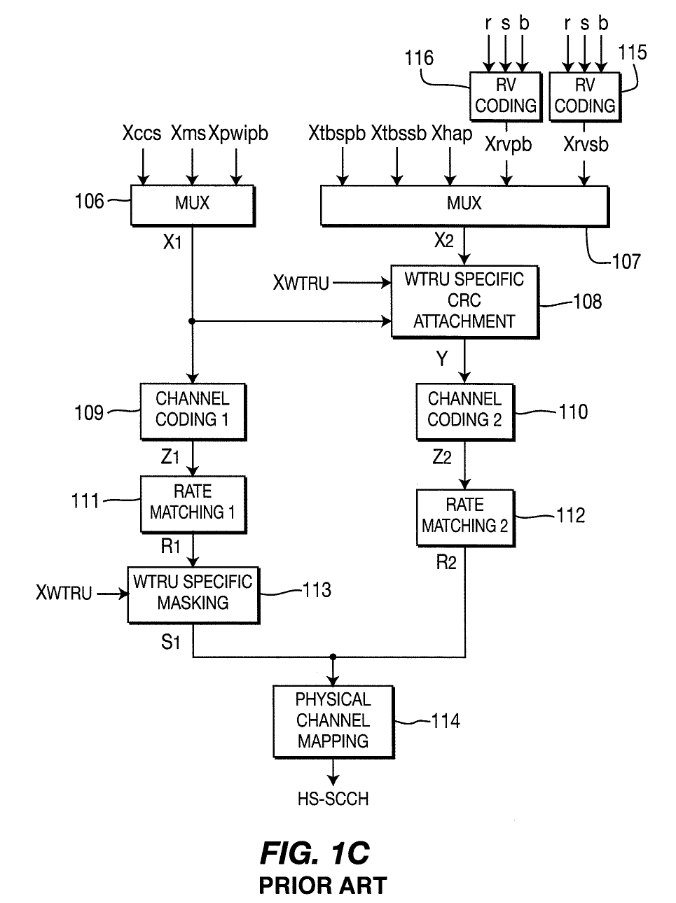

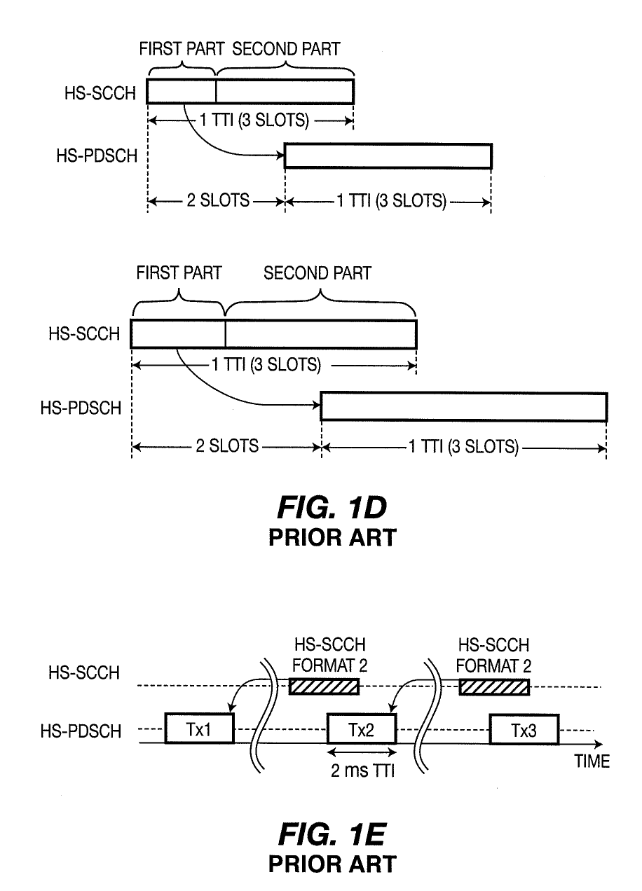

FIG. 4 shows a diagram for the HS-SCCH type 2M coding. Parameters are X_{ccs}, Xₘₛ, X_{pwipb}, X_{WTRU}, special information type (X_{type}), and special information (X_{info}), similar components as described in FIG. 1C.

Referring to FIG. 4, the sequence of bits X₁, X₂, Z₁, Z₂, R₁, R₂, S₁, and Y include a respective number of bits for its inputs. X_{type}, and X_{info} are combined (420) to generate X₂. The X₂ information and identity of the WTRU (X_{WTRU}) along with X₁ are supplied to WTRU specific CRC attachment (430) to generate Y bits. Also, X_{ccs}, Xₘₛ and X_{pwipb} are combined (410) to generate X₁. X₁ and Y are used for channel coding 1 (440) and channel coding 2 (450) to encode into vectors and outputs it as Z₁ and Z₂ for rate matching 1 (460) and rate matching 2 (470), respectively. The WTRU specific masking (480) takes in the identity of the WTRU to input the masking into the Physical Channel Mapping (490) for output of the HS-SCCH.

Transmit Diversity Selection for HS-SCCH-Less Operations

An alternative approach to improve the efficiency of the MIMO mode of operation in the presence of low-data-rate packet services is to use a different type of transmit diversity. This may be a space time transmit diversity (STTD), closed-loop, no diversity, etc., which may be used for the HS-PDSCH in the HS-SCCH-less operations. Therefore, the precoding weight vector no longer needs to be transmitted, and regular HS-SCCH-less operations may be used. For low-data-rate packet services, dual-stream MIMO is not likely to be used and this alternative may be advantageous.

Implicit HS-SCCH-less transmit diversity may be used to inform the WTRU of the transmit diversity mode employed for the HS-PDSCH transmission in the HS-SCCH-less operations. If the WTRU is configured in the MIMO mode and the HS-SCCH-less mode simultaneously, then the first transmission of a given transport block on the HS-PDSCH is transmitted using either of the following: a) A pre-defined or configured transmit diversity mode (e.g., STTD or closed loop); b) A transmit diversity mode (e.g., STTD or closed loop), specific to the HS-PDSCH, signaled by higher layer upon configuration; or c) the same transmit diversity mode as another associated channel (such as the HS-SCCH). The transmit diversity mode for this associated channel is signaled by the higher layer. The choice of associated channel may be pre-defined or signaled by higher layers.

Furthermore, the second and third transmission of the transport block on the HS-PDSCH may be transmitted using either: the MIMO mode, in which case the HS-SCCH type 2M described above may be used; or, another transmit diversity mode signaled in the first part of a new HS-SCCH type. For example, the proposed HS-SCCH type P with a modified interpretation of the information bits may be used for this purpose.

Because the HS-SCCH type 2M is transmitted for the second and third transmission, it is natural to include the PWI as part of the message and use MIMO. In this regard, the HS-SCCH type 2M as described above may be used. The PCI or CQI reporting procedure is unaffected when using this approach.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for communication of packet services implemented in a multiple input multiple output (MIMO) capable wireless transmit receive unit (WTRU), the method comprising:
determining a precoding weight information (PWI);
receiving a high speed physical downlink shared channel (HS-PDSCH); and
decoding the HS-PDSCH based on the PWI.

2. The method as in claim 1, wherein the PWI is determined based on a high speed shared control channel (HS-SCCH) transmission previously received by the WTRU.

3. The method as in claim 1, wherein the PWI is determined based on a high speed dedicated physical control channel (HS-DPCCH) transmission previously received by the WTRU.

4. The method as in claim 1, wherein the PWI is determined based on a first high speed shared control channel (HS-SCCH) transmission received by the WTRU.

5. The method as in claim 1, wherein the PWI is determined based on a first high speed dedicated physical control channel (HS-DPCCH) transmission received by the WTRU.

6. The method as in claim 1, wherein the PWI is determined based on a pre-defined precoding weight vector that is received from higher layers.

7. The method as in claim 1, wherein the PWI is determined based on a high speed shared control channel (HS-SCCH) transmission of type 3.

8. The method as in claim 1, wherein the PWI is determined based on a high speed shared control channel (HS-SCCH) transmission of type P.

9. The method as in claim 1, wherein the PWI is determined based on a high speed shared control channel (HS-SCCH) transmission of type 2M.

10. A wireless transmit receive unit (WTRU), the WTRU comprising:
a receiver configured to receive a high speed physical downlink shared channel (HS-PDSCH);
a processor configured to determine a precoding weight information (PWI), and wherein the processor further configured to decode the HS-PDSCH based on the PWI.

11. The WTRU as in claim 10, wherein the PWI is determined based on a high speed shared control channel (HS-SCCH) transmission previously received by the WTRU.

12. The WTRU as in claim 10, wherein the PWI is determined based on a high speed dedicated physical control channel (HS-DPCCH) transmission previously received by the WTRU.

13. The WTRU as in claim 10, wherein the PWI is determined based on a first high speed shared control channel (HS-SCCH) transmission received by the WTRU.

14. The WTRU as in claim 10, wherein the PWI is determined based on a first high speed dedicated physical control channel (HS-DPCCH) transmission received by the WTRU.

15. The WTRU as in claim 10, wherein the PWI is determined based on a pre-defined precoding weight vector that is received from higher layers.

16. The WTRU as in claim 10, wherein the PWI is determined based on a high speed shared control channel (HS-SCCH) transmission of type 3.

17. The WTRU as in claim 10, wherein the PWI is determined based on a high speed shared control channel (HS-SCCH) transmission of type P.

18. The WTRU as in claim 10, wherein the PWI is determined based on a high speed shared control channel (HS-SCCH) transmission of type 2M.

19. A method for communication of packet services implemented in a multiple input multiple output (MIMO) capable wireless transmit receive unit (WTRU), the method comprising:
receiving a transmission over a high speed shared control channel (HS-SCCH) of type P;
determining a precoding weight information (PWI) based on the transmission; and
associating the PWI with a channelization code of a high speed physical downlink shared channel (HS-PDSCH).

20. A wireless transmit receive unit (WTRU), the WTRU comprising:
a receiver configured to receive a transmission over a high speed shared control channel (HS-SCCH) of type P; and
a processor configured to determine a precoding weight information (PWI) based on the transmission, and associate the PWI with a channelization code of a high speed physical downlink shared channel (HS-PDSCH).
